(19) United States
(12) Patent Application Publication
(10) Pub. No.: US 2016/0236977 A1
(43) Pub. Date: Aug. 18, 2016

(54) USE OF SPENT SHALE OR ASH OBTAINED FROM OIL SHALE DISMANTLING METHODS WITH OR WITHOUT ADDITIVES AS SOLID FUEL

(71) Applicant: INVESTMENT FOR OILY SHALE TECHNOLOGIES CO. LTD., Amman (JO)

(72) Inventor: Al Ahmad TRAD, ANKARA (TR)

(73) Assignee: INVESTMENT FOR OILY SHALE TECHNOLOGIES CO. LTD., Amman (JO)

(21) Appl. No.: 15/028,029

(22) PCT Filed: May 13, 2014
(86) PCT No.: PCT/TR2014/000163

§ 371 Date: Apr. 8, 2016

(30) Foreign Application Priority Data
Oct. 11, 2013 (TR) PCT/TR2013/000319
Dec. 18, 2013 (TR) 2013/14919
Dec. 18, 2013 (TR) 2013/14922

(51) Int. Cl. C04B 7/30; C04B 33/32; B01J 20/02; F16L 59/02

(52) U.S. Cl. CPC C04B 7/30; F16L 59/028; C04B 33/32; B01J 20/02

(57) ABSTRACT

In the present invention a method for producing solid fuel is developed. According to the method, spent shale, ash obtained by high temperature oil shale dismantling process, treated spent shale, ash obtained from direct burning of oil shale, ash obtained from indirect burning of oil shale or any mix of them is used as solid fuel without any additives or with organic and inorganic additives. The ignition temperature of the fuel is higher than 300° C., the speed of air flow in the burning chamber is higher than 5 m/s and oxygen may be added to improve burning efficiency during the burning process.

### FIELD OF THE INVENTION

The present invention relates to a solid fuel with high thermal content which is called solid fuel. The main component of the solid fuel is the ash resulting from the process of oil shale treatment or oil shale dismantling process.

### BACKGROUND OF THE INVENTION

Rocks are the main components that make up the Earth.

Thermal energy is considered the backbone of any industry and its main engine, and the need for energy is increasing with development and civilization, so, to face this demand; large amounts of energy, clean energy resources, and sensible prices are required.

solid fuel is a solid fuel with high thermal content (heating capacity).

In the traditional oil shale dismantling processes under low temperatures; the residuals of this process cannot be completely free from the organic materials. The percentage of the organic materials that remains is in the range of 5% to 40%. This residual from the oil shale process is so-called spent shale.

The residue obtained by the oil shale dismantling processes under high temperatures tends to separate the organic and inorganic materials from the oil shale during the processing, resulting to what is called ash obtained by high temperature oil shale dismantling process.

Accordingly, the resulting ash from this process is claimed to be equivalent to the spent shale but with neglectable (negligible) percentage of the organic materials.

The ash to be used in production of solid fuel can be spent shale, ash obtained by high temperature oil shale dismantling process, treated spent shale or any mix of them.

Organic and inorganic additive materials are added. The amount of additives are determined related to the amount of energy required and the area of use such as production of clinker, cement etc.

Rocks are the main components that make up the Earth. Minerals are elements that make up the rock.

Chemical analysis, and empirical studies on the various types of rocks from the surface of the earth and in its interior at different depths, showed that a limited number of chemical elements are key components of the different types of rocks on the earth's surface and in the interior, these elements are:

| Name of the | | |
|---|---|---|
| element | Symbol | Presence % |
| Oxygen | O | 46.6 |
| Silicon | Si | 27.7 |
| Aluminum | Al | 8.13 |
| Iron | Fe | 5 |
| Calcium | Ca | 3.63 |
| Magnesium | Mg | 2.09 |
| Sodium | Na | 1.32 |
| Potassium | K | 1.23 |

These elements are key components of any type of rock, while the rest of the elements known and studied, do not exceed a total of 1.5% of the weight of the Earth's crust. Oxygen is the most important element and it displays electrical properties in the rocks of the Earth's crust.

Silicon comes first in the ability to combine with any element, such as Sio₂, carbon is next, and then sulfur, phosphorus, and then nitrogen.

Silicates and oxides are the basic and main components of the rocks, rather than carbonates, sulfates, phosphates or nitrates.

The importance of oxygen as a key component in the rocks of the Earth's crust is presented in the crystal compounds found in rocks, the elements (K, Na, Mg, Ca, Fe, Al and Si) appear surrounded and connected to the oxygen atoms, but in fewer degrees.

Elements (Fe, Cl and S) play the role of oxygen:

Most of the rocks contain sufficient oxygen for bonding with elements of positive atomic weights, these compounds are called metal oxides and its percentages are summed up to 100% without specifying the percentage of oxygen directly, oxides of Silicate rocks are: SiO₂, Al₂O₃, FeO, Fe₂O₃, CaO, MgO, Na₂O, K₂O, TiO₂, P₂O₅, and H₂O.

Carbonate rocks specifies the percentage of CO₂ and sulfate rocks specifies the percentage of SO₂.

Rocks that make up the Earth's crust have developed as a result of effective geological processes through a long geological time. These operations contributed to the construction of some types of rocks, and destruction of other types, but the rock cycle starts from molten rock to igneous rocks and then to deposits followed by sedimentary rocks followed or proceeded by a metamorphic phase that produced metamorphic rocks.

Rocks on the earth exposed to the impact of air, water and weather conditions of hot, cold and other weather effects, those operations are called rock weathering.

Chemical and mineral composition of the rocks:

The structure of the rocks starts from the underground melt stage, and then the weathering factor manipulated it to several kinds of rocks which are:

Igneous rocks: These rocks are structured from solidification process of the rock's magma that was emitted from the underground. The following table shows the rate of the major oxides in igneous rocks:

| Oxide name | Chemical Symbol | Existence percentage by weight % |
|---|---|---|
| Silicon dioxide | SiO₂ | 59.14 |
| Aluminum oxide | Al₂O₃ | 15.32 |
| Ferric oxide | Fe₂O₃ | 3.08 |
| Ferrous oxide | FeO | 3.8 |
| Magnesium oxide | MgO | 3.49 |
| Calcium oxide | CaO | 5.08 |
| Sodium oxide | Na₂O | 3.84 |
| Potassium oxide | K₂O | 3.13 |
| Water | H₂O | 1.15 |
| Titanium dioxide | TiO₂ | 1.05 |

The igneous rocks consist of the main following elements: Si, Al, Fe, Mg, Ca, Na, K and O.

The main oxide is Silica with a percentage of (52.5-73.5)%.

Sedimentation: A geological process resulting from the overlap of the atmosphere and hydrosphere on the earth's crust.

Sedimentary rocks: representing 5% of the rocks of the Earth's crust, and is considered as a product resulting from the fragmentation of metamorphic or igneous rocks, its chemical composition varies and it can be in the form of shale, sand stone, or limestone with the following proportions 1%, 3% and 16% are for the shale, sandstone and limestone respectively.

| | | Igneous | Sedimentary | |
|---|---|---|---|---|
| | Chemical | Rocks | rocks | Difference |
| Name oxide | Symbol | (%) | (%) | (%) |
| Silicon dioxide | SiO₂ | 59.8 | 59.46 | −0.34 |
| Aluminum oxide | Al₂O₃ | 15.5 | 1.1 | −4.6 |
| Ferric oxide | Fe₂O₃ | 3.11 | 1.74 | −0.01 |
| Ferrous oxide | FeO | 3.84 | 1.96 | −2.11 |
| Magnesium oxide | MgO | 3.52 | 15.6 | −1.56 |
| Calcium oxide | CaO | 5.14 | 3.07 | 10.46 |
| Potassium oxide | K₂O | 3.16 | 2.27 | −0.09 |
| Sodium oxide | Na₂O | 3.88 | | −1.06 |

The chemical composition rates of the sedimentary rocks are: Shale 82%, 12% and 6% for the shale, Sandstone, and Limestone respectively.

The mineral composition rates of the sedimentary rocks are:

| Metals | Shale % | Sandstone % | Limestone % |
|---|---|---|---|
| Quartz | 22.3 | 66.8 | 4.7 |
| Feldspar | 30 | 11.5 | 0 |
| Metal Clay | 25 | 6.6 | 2.1 |
| Limonite | 5.6 | 1.8 | 0.5 |
| Carbonates | 5.7 | 11.1 | 92 |
| Others | 11.4 | 2.2 | 0.7 |

Metamorphic rocks: Rocks of secondary origin that came from the mineral transformations that have occurred in the sedimentary and igneous rocks, so, its chemical composition is in between of both of them.

For example, the transformation of the shale rocks is illustrated by the following equation:

Shale→Slate→Phyllite→Micashist→Gneiss

Metals: elements formed by natural inorganic processes and are distinct from each other by their physical, chemical natural optical, electrical and magnetic characteristic, in addition to the chemical composition and crystal structure belonging to it.

Crystal chemistry science aims to clarify the relationship between the chemical composition, internal structure and natural characteristics in crystalline materials, in addition to the manufacture of crystalline materials.

Chemical bonds: Ions or atoms are bonded with each others in the crystal with electric powers and which makes them non-ionic bonds when appearing in salts.

Covalent bonds appear in diamond, Metallic bonds appear in the metals and the Vander Vals bonds which are responsible for the gases cohesion.

Based on the nature of the bonds in the crystals, the crystals are classified into five categories which are:

Ionic Crystals, covalent crystals, molecular crystals and metallic crystals.

Polymorphism: An element or a compound that can have more than one atomic arrangement where a distinction is made between two types of interactions:

1) Reversible: occurs in specific temperature and pressure, such as the following transformation:
Pressure (1) Temperature 867 C
Quart [symbol] Tridymite

2) Irreversible: Does not require a degree of pressure and temperature
Marcasite→Pyrite

To achieve compatibility between the shale ashes resulting from the oil shale processing and the appropriate additives required to produce a solid fuel (solid fuel) and which can be used in various industrial fields, adequate thermal energy is needed. For example: Generation of electrical energy is performed under (450 to 650)° C. and the cement industry is performed under 1450° C., in addition to the thermal energy generation.

The remaining solid fuel and knowledge of its composition, its physical and chemical characteristics in order to introduce it to the right industrial field, for example the properties of materials used in cement must be known, as well as knowledge of finest composition of the cement to balance the ash and additives used for solid fuel production that achieves the required thermal energy and the remaining solid fuel is an important raw material for a wide range of basic industries.

The chemical composition of raw materials:

| Name of | CaO | SiO₂ | Al₂O₃ | Fe₂O₃ | MgO | Loss |
|---|---|---|---|---|---|---|
| crude | (%) | (%) | (%) | (%) | (%) | (%) |
| Lime Stone | 52 | 5.7 | 0.8 | 0.3 | 0.4 | 40.4 |
| Shale | 3.2 | 53.8 | 18.9 | 707 | 202 | 13.1 |
| Sand | 0.8 | 70 | 15 | 5 | 0.2 | 8.6 |
| Clay | 0.5 | 61 | 16.9 | 12.4 | 0.4 | 7.8 |

The temperatures for the reactions occurring in cement production furnaces are shown in the table below with its interactions:

| Approximated | |
|---|---|
| Temperature | |
| (° C.) | Interaction name |
| 100 | Evaporation of free water in raw materials |
| 500 | Expelling the united water with clay |
| 805 | Expulsion (CO₂) from limestone (CaCO₃) |
| | CaCO₃→CaO + CO₂ |
| 900-1200 | Forming C₂S as a result from the interaction |
| | between CaO and 2SiO which gives 2CaO—SiO₂ |
| | (Bilateral calcium silicate bilateral) |
| 1260 | FormingC₃S as a result from the interaction between CaO |
| | and SiO₂ which gives |
| | The forming is related increasing the temperature with |
| | more lime to get to class of 1370 C., and at this |
| | temperature the clinker must clinker be burnt to get |
| | the high-quality clinker 3CaO—SiO₂(Tri-calcium |
| | Silicate) |
| 1370 | FormingC₃A as a result from the interaction between |
| | CaO and Al₂o₃ which gives 3CaO—Al₂o₃ |
| | (Triple calcium illuminate) |
| 1425 | FormingC₄AF as a result from the interaction between |
| | CaO, Al₂o₃ and Fe₂o₃ which gives4CaO—Al₂O₃—Fe₂O₃ |
| | (Freight Alumina quadrant calcium) |

To achieve solid fuel with exceptional high thermal content, and a model composition of typical cement, it is required to maintain the following criteria:
9—Silica Ratio

$$SR = \frac{{SiO}_{2}}{{Al}_{2} {O}_{3} + {Fe}_{2} {O}_{3}} \qquad ( 1 )$$

Increasing of SiO₂ gives clinker that is difficult to burn.
The thermal content of Al₂O₃ and FeO₃ organize SiO₂ and CaO union.
At low sintering levels; MgO behaves as a liquefied material to help in facilitating the combustion process, its increase leads to balling and harming the quality of concrete.
in sand and clay there are Na₂O and K₂O that cause exhausted ring formations which play harmful role on the furnace internal walls.
The meaning of easy burning/combustion cement; is the cement that requires little amount of fuel to be burnt.
The meaning of difficult burning/combustion cements, is the cement which requires more fuel to be burnt.
10—The alumina-Ferric Ratio (% Al/Fe) is shown in the following equation:

$$\% Al \text{\textbackslash} Fe = \frac{{A}_{2} {O}_{3}}{{Fe}_{2} {O}_{3}} \qquad ( 2 )$$

When the ratio shown in equation 2 increases, the combustion becomes harder.
Iron has a desirable role in accelerating the reaction between lime and silica.
11—Lime Saturation Factor (LSF):

$$LSF = \frac{100 CaO}{2.8 {SiO}_{2} + 1.1 {Al}_{2} {O}_{3} + 0.7 {Fe}_{2} {O}_{2}} \qquad ( 3 )$$

When the SFT increases, the combustion becomes harder.
12—The percentage of the liquid existed at the clinker temperatures:

percentage=1.13C₃A+1.35C₄Af+MgO+Alkali (4)
The high percentage is an indicator that the combustion of clinker is easier.
13—Burnability indicator (BI):

$$BI = \frac{{C}_{3} S}{{C}_{3} AF + {C}_{3} A} \qquad ( 5 )$$

Increasing BI makes the clinker burning to become harder.
increasing C₃S and decreasing either C₃A or C₄AF makes the clinker burning to become harder.

### Cement Composition Model:

The following table shows the cement composition model:

| | | |
|---|---|---|
| Calcium Oxide % | CaO | 64.4 |
| Silicon dioxide % | SiO₂ | 22.2 |
| Alumina % | Al₂O₃ | 3.5 |
| Ferric oxide % | Fe2O₃ | 2.9 |
| Magnesium Oxide % | MgO | 2.2 |
| Sulfur tri oxide % | SO₃ | 2 |
| Loss by burning-non decomposed remains % | | |
| Total Alkali % | Na₂O and K₂O | 0.45 |
| Lime % | CaO | 0.9 |
| Tri-calcium Acuminate % | C₃A | 6.8 |
| Tri-calcium Silicate % | C₃S | 54 |
| Di-calcium Silicate % | C₂S | 22.9 |
| Tetra calcium Alumina ferrite % | C₄AF | 8.8 |

For the exact values of the criteria that show the typical composition of the cement, it is needed to go back to the previous equations that are associated with the typical composition of the cement to find:

$$From equation 1 ) SR = \frac{22.2}{3.5 + 2.9} \to SR = 3.46 \\ From equation 2 ) \frac{Al}{fe} = \frac{3.5}{2.9} \to \frac{Al}{fe} = 1.2 \\ From equation 3 ) \frac{Al}{fe} = \frac{3.5}{2.9} \to \frac{Al}{fe} = 1.2$$

From equation 4) Percentage=0.45+2.2+8.8×1.35+6.8×1.13
   Percentage=22.21
From equation 5) BI=2.6−4.5.

The optimal Portland cement of class E, requires raw materials with percentages that assures the Silica Ratio (2.5-3.5), LSF (90-95), Percentage of liquid material (20-27), and BI (2.6-4.5).

The effect of chemical composition on BI to determine the BI for a certain mixture; two mixtures are chosen with the following percentages shown in the two tables below:

| | CaO | SiO₂ | Al₂O₃ | Fe₂O₃ | MgO | Alkalis | C₃S | C₃A | C₄AF |
|---|---|---|---|---|---|---|---|---|---|
| Mixture Number | (%) | (%) | (%) | (%) | (%) | (%) | (%) | (%) | (%) |
| 1 | 65.65 | 22.15 | 4.99 | 3.03 | 4.72 | 0.1 | 58.87 | 8.1 | 9.22 |
| 2 | 64.79 | 11.88 | 5.77 | 1.83 | 4.48 | 0.2 | 48.51 | 12.2 | 8.57 |

Percentage of the relative burning ability: The percentage of the burning ability is illustrated through the study of the data for the two mixtures which are shown in the table below:

| Mixture | Saturation | Silica | Liquid | Burningability | Burnability |
|---|---|---|---|---|---|
| Number | Factor % | Ratio % | material % | Indicator % | Factor |
| 1 | 93.5 | 2.76 | 26.42 | 3.4 | 106.6 |
| 2 | 90.04 | 3.05 | 25.99 | 3.61 | 106.9 |

By concluding the data in the two mixtures above; it can be observed that Mixture (1) is easier to be burnt than Mixture (2). If Gypsum was added to the mixture with the purpose of not allowing Alkalis to merge with the gases in the furnace, vision in the area of combustion significantly decreases.

Some of the Cement formation reactions are reversible, specifically in the area of combustion, the clinker produced in that area has to be immediately and quickly cooled to avoid obtaining such reversible reactions that result to a low quality product, as demonstrated in the following equation:

C₃S [symbol] C₂S+free Ca

### Thermal Reactions:

The thermal amount of a compound and decomposition are equal in the quantity and opposing in direction, in addition, this thermal amount depends on the status of the deteriorated compounds.

The slaw cooling leads to form C₃S and C₄AF in crystal form with taking into consideration that the thermal amount needed to form C₃S is larger than the thermal amount needed to form C₂S.

### Oil Shale:

The oil shale is defined as fine crystals sedimentations that occur in different forms such as sedimentary limestone, sedimentary silicon rocks, sedimentary and clay rocks.

Microscopic study showed that basic mass of the Mastrecht and Eocene oil shale are similar and belong to the sedimentary lime rocks, silicon rocks and sedimentary clay rocks, of organic structure that look like unique or multiple moles/cells, big ones with Lime form and the small ones in the form of Dolomite and sometimes phosphate.

The moles/cells are filled with hydro carbonate material, where that Mortar is a microscopic crystals composed of Calcite and clay, that appears in yellow or brown color because of the absorption of the hydrocarbonate materials, it also sometimes appears in the form of Dolomite or phosphate crystals, Quartz fragments and phosphorous knots.

The components of the oil shale are restricted to the following basic ones:
The organic material has an irregular distribution; most of it is Kerogen which is associated with Bitumen. By proper thermal processing; the shale gas, shale oil and water are obtained.
Alvhmaúah Metals contains large percentages of carbonates, Calcite making up the bigger portion and remaining is Dolomite
Debris materials are Quartz, Clay, Wlosbat, and Apatite, in addition to some of Phosphorus fragments. Debris Material and Alvhmaúah metals are considered the main components of the solid fuel and by processing them; the solid fuel residual is obtained.
Unique elements form the sedimentation of the oil shale need to be taken into consideration when the oil shale is evaluated; these elements according to their concentration in the oil shale processed residual contains Titanium, Barium, Strontium Zinc, Vanadium, Molybdenum, and Uranium and negligible amount organic materials.

Thermal energy is considered the backbone of any industry and its main engine, and the need for energy is increasing with the development and civilization, so, to face this increasing in the demand; large amounts of energy, clean energy resources, and sensible prices are required to be fulfilled. Oil shale can fulfill those demands and organizes the processes of the energy flow, in addition to conserving the balance and cleanliness of planet earth and protecting it from the disasters, as the structural units are balanced and aims for stability according to a precise system without exposing it to disasters that could lead to destruction and diminish, such as the nuclear plants.

By proposing and applying the following equation with the best available technologies:

Oil Shale=Natural gas+Crude oil+Coal

Ideas in which the solid fuel is built on:
14—Fe₂O₃ powder is mixed well (with the portion of 80 particles) with the Al powder (with a portion of 72 particles) in a crucible that tolerates very high temperatures, on the surface of the mixture another layer of a powder mixture (Al+BaO₂), then the mixture is ignited with Mg, a reaction then takes place with the release of large amount of energy according to the following equation:

2Al+Fe_{2O3}→Fe+Al₂O₃+200 Kcal
The released thermal energy is sufficient to melt the formed Iron, it flows down the crucible, and the Al₂O₃ floats on the surface of the melt.
15—Aluminum powder is mixed well with Sulfur and in the presence of high temperature a chemical reaction takes place, releasing large amount of thermal energy and forming Aluminum Sulfide Al₂S₃
16—When heating Zn to the temperature of 900 C and in the presence of the Oxygen; Zn gets burnt giving blue-green flame and forming white smoke (ZnO) which releases large amounts of thermal energy as shown in the following equation:

2Zn+O₂→2ZnO+170 kcal
Zn powder is mixed well with Sulfur then the mixture is ignited with Mg, the mixture burns strongly forming ZnS, that is yellowish white in color and the reaction produces large amounts of thermal energy.
Iron Fe filing is (7 portions) mixed with Sulfur S (4 portions) then the mixture is ignited with Mg, a reaction takes place releasing thermal energy, the temperature is elevated to the degree of redness forming black iron sulfide FeS.

All these ideas together dedicated enough drive to elevate the furnace temperature within (600 to 950)° C., within this range, reactions releasing energy take place.

If the organic analysis carried over oil shale samples is studied, then another analysis carried out over the inorganic samples, and within the temperature range mentioned, it is found out that all reactions based on those concepts do take place in addition to other reactions. These other reactions introduce the oil shale additives after extracting gas and oil from it to achieve a new type of solid fuel that we called solid fuel

### Analysis Results Carried on Oil Shale:

Based on the obtained practical results; a relation between the chemical content of oil shale and oil shale ash is found. This relation leads to the idea of creating the solid fuel; accordingly, full analysis for the oil shale structure and its ash is performed and then joined to determine the additive materials to the ash in order to convert it to solid fuel.

The following tables show the results of the oil shale structure (Organic aspect) and its ash (inorganic aspect):

### Organic Aspect Results:

| Borehole | iNat-8 | iNat-5 | iNat-5 | iNat-5 | iNat-4 | iNat-4 | iNat-4 |
|---|---|---|---|---|---|---|---|
| Calorifie | 1088 | 1221 | 1210 | 2026 | 1598.5 | 1547.72 | 774.58 |
| Value K.Cal | | | | | | | |
| Cory | 8.94 | 11.35 | 11.04 | 12.07 | 12.66 | 10.88 | 10.12 |
| wt % | | | | | | | |
| Total S wt % | 1.4 | 1.43 | 1.36 | 2.05 | 2.94 | 2.64 | 1.15 |
| Total H | 1.25 | 1.67 | 1.61 | 1.73 | 1.97 | 1.84 | 1.27 |
| wt % | | | | | | | |
| Total C | 20.75 | 20.68 | 20.39 | 23.74 | 21.18 | 16.08 | 19.76 |
| wt % | | | | | | | |
| Gas loss | 1.84 | 2.64 | 4.84 | 5.95 | 5.76 | 3.97 | 5.26 |
| wt % | | | | | | | |
| Spent shale | 90.22 | 86.64 | 86.64 | 82.63 | 82.94 | 84.45 | 88.2 |
| wt % | | | | | | | |
| Total oil wt % | 7.34 | 9.3 | 9.34 | 9.67 | 10 | 8.85 | 4.74 |
| Total water | 1.2 | 1.60 | 1.40 | 1.75 | 1.3 | 3 | 1.8 |
| wt % | | | | | | | |
| Misture | 0.66 | — | — | — | — | — | — |
| content | | | | | | | |
| mt % | | | | | | | |
| From (m) | 116 | 95 | 90 | 70 | 115 | 105 | 95 |
| To (m) | To | To | To | To | To | To | To |
| | 120 | 100 | 95 | 75 | 120 | 110 | 100 |
| Sample | 2153 | 2212 | 2211 | 2197 | 2292 | 2287 | 2130 |

### Analysis Results Carried on Oil Shale Ash (Inorganic Aspect)

### Inorganic Aspect

| | iNaT-4 | | | iNaT-5 | | | |
|---|---|---|---|---|---|---|---|
| Borehole | Test 1 | Test 2 | Test 3 | Test 1 | Test 2 | Test 3 | INat-8 |
| L.O.I | 26.5 | 45.2 | 43.20 | 45.4 | 46.5 | 46 | 46.3 |
| K₂O | 5.22 | 5.2 | 5.11 | 5.22 | 5.21 | 5.21 | 5.59 |
| SO₃ | 2.8 | 1.37 | 1.87 | .02 | 0.36 | 0.44 | 0.16 |
| Na₂O | 0.08 | 0.22 | 0.07 | 0.17 | 0.1 | 0.11 | 0.07 |
| MgO | 9.05 | 0.35 | 0.45 | 0.61 | 0.51 | 0.53 | 0.51 |
| Al₂O₃ | 1.8 | 2.09 | 1.22 | 1.81 | 1.71 | 1.75 | 1.12 |
| SiO₂ | 16.2 | 10.08 | 7.56 | 9.72 | 9.72 | 9.53 | 10 |
| P₂O₅ | 2.16 | 0.99 | 2.97 | 1.72 | 1.66 | 1.72 | 0.86 |
| CaO | 28.5 | 29.8 | 41.5 | 36.9 | 37 | 37.8 | 45.5 |
| TiO₂ | 0.08 | 0.1 | 0.05 | 0.08 | 0.08 | 0.08 | 0.05 |
| MnO | 0.001 | 0.002 | 0.002 | 0.001 | 0.002 | 0.001 | 0.001 |
| Fe₂O₃ | 0.71 | 0.79 | 0.44 | 75 | 95 | 100 | 0.57 |
| From | 105 | 115 | 95 | 70 | 90 | 95 | 116 |
| To | To | To | To | To | To | To | To |
| | 110 | 120 | 100 | 100 | 95 | 75 | 120 |
| Sample | 2287 | 2292 | 2130 | 2212 | 2211 | 2197 | 2153 |

### Introduction to the Solid Fuel and Solid Fuel Additives:

It is important to differentiate between materials that are able to be burnt to release thermal energy at low temperatures like Diesel, fuel oil and depleted oil, and the material that can be burnt but at high temperatures, like the ashes resulting from oil shale when extracting gas and oil from it.

The ability of the ash to be burnt is recognized from the reaction of CaCo₃ with SiO₂ and Al₂O₃ and Fe₂O₃, since without this reaction of those compounds; C₂S and C₃S will not be produced in addition to C₄AF and C₃A, which are also part of the thermal reactions used to produce the clinker. However, those chemical reactions wouldn't have occurred if appropriate conditions were not fulfilled with the specific additives.

The thermal energy released can be controlled and used, in order not to have a rapid reaction accompanied with high energy that significantly elevates the temperatures inside the furnace. However, good care should be taken to avoid the negative affect over the reaction medium as a result of the combustion in the furnace through the operations of the oil shale treatment. The additives are many and various. The main aim is to achieve solid fuel having high energy content and clean combustion energy that does not harm the essential life elements. The solid fuel residual can be greatly benefited as an entrance to several and basic industries.

The human contribute to destroy the nature without noticing this action; indeed, the cement industry uses Lime stone, clay, and silica sand in addition to Basalt, this is accompanied by transportation processes, crushing, grinding, blending and mixing with water to homogenize, use of fuel for machinery, use of electricity for these processes, the large amounts of water associated, wear and tear of the crushers, mills, conveyer belts and the lining of the furnaces, add to all this that production of 1 ton cement requires burning 160 kg of traditional liquid fuel oil. All these processes are not observed and are not counted in the environmental calculations, it is said that those projects are launched in the desert areas where the natural resources are available. However, when doing so, can it always been argued that it is maintained the motto “Petroleum is more precious to be burnt” as it should be directed to more important industries that have no effect on the environment and guarantees economic benefit and developmental qualities which is positively reflected on the progress of civilization, and familiar with scientific rules and making sure it is carefully applied regulates the use of energy and guarantees its flow in huge amounts with reasonable prices, and addition to the reservation of the beauty of nature even of it was a desert.

Work with these criteria in a scientific approach by relying on scientific rules as maintaining the energy and mass laws and taking into account the cleanliness of the energy and the reasonability of its price. In conclusion; the civilization criteria dictates that the energy sources should be safe and not accompanied with disasters when generating large amounts of clean energy for reasonable prices.

The proposed invention deals with the oil shale treatment technology which suggests a scientific and logical investment project for oil shale treatment, based on industrial experiments using an execution unit performed by a pilot plant that can have a commercial production line that gives important economic indicators on the return on investment, and with processes that finely affects the environment according to the following equation:

Oil Shale=Natural gas+Crude oil+Coal

Analyzing the previous equation with more details gives more general form shown in the following equation:

Oil Shale=Shale gas+Shale oil+Water+Hot air+solid fuel=Coal+Crude oil+Natural gas

### The Origin and Content of the Solid Fuel:

The main components of the solid fuel is the ash which is a result of oil shale treatment, taking into consideration that the ash is comprised of flammable material when reacting with each other, and most of its reactions are regarded as energy releasing reactions.

The ash consists of TiOs, Na₂O, K₂O, SO₃, MgO, Fe₂O₃, Al₂O₃, SiO₂, CaO and negligible amount organic materials. Those oxides react with each other in an appropriate reaction medium, a proof of this is the reaction of Lime stone with the sand in the presence of clay and Basalt, the reaction medium is the furnace, where those reactions take place gradually and the results are the formation of: C₂S and C₃S in addition to C₄AF (four carbonate Flouride aluminum) and C₃A (third carbonate aluminum), then the combustion reactions begin that assures the reaction of those compounds with each other with adequate high temperatures, where clinker is produced, the clinker is then cooled, specific additives are added to it before being grinded to obtain shale cement.

From the studies of the chemical structure of the oil shale and oil shale ash, it is observed the presence of carbonates (Calcite, Dolomite, Silica Quartz, metal clay, Ellite, Vitmoriolonate, Pyrite, Magnazite, Apatite, and phosphorus fragments).

The lab analysis that was carried on the ash, indicates that the percentage of the ash resulting from oil shale treatment is between (56%-86%) and this ash contains a high a percent of CO₂ (24%-38) %, where the percentage of CaO is (3-48)%, Al₂O₃(0.5-3.3)%, Fe₂O₃(0.4-2)%, MgO(0.5-3)%, and (K₂O+Na₂O=0.3)%.

The value indicating the melting temperature of the ash is (B=0.05-0.35), where B is the ability to burn the clinker and calculated from the following equation:

$$B = \frac{{SiO}_{2}}{{Al}_{2} {O}_{3} + {Fe}_{2} {O}_{3} + CaO + MgO}$$

The inorganic Sulfur percent is (0.7-2.9)% in addition to the presence of other important metal elements, the percentages of their presence is represented by P.P.M. (Par Partitioning Million).

Use of Ash Obtained from Oil Shale Dismantling Process

Ash obtained from oil shale dismantling process can be used in grinded form as active carbon for; liquids and gases purification and filtering processing without any additives.

In the mixtures in this invention the percentages are given by weight of the ingredients of the mixture.

### Solid Fuel Additives:

The most basic additive material is the air, which is added to the hot ash to keep it burnt continuously.

The mechanism of adding the air and the burning process is shown below:

Making use of air is through multi use turbines of different types:
4—A turbine to push the solid fuel into inside the furnace in order to reach the combustion area.
5—Suction/Wrenching Turbine, the suction role is to suck the air to provide the combustion with oxygen required for the combustion, the speed of air flow is above 5 m/s preferably 40 m/s to 140 m/s and the amount should be always adjusted. The amount of air is determined by the size of the furnace and the temperature at which combustion takes place. The wrenching role is to pull the residues and the gases of the combustion process, purifying the gases then pushing to a heat exchanger, hot air can be used in other chemical processes as no need to return this air to the furnace.
   Any malfunctioning of any of the turbines would have negative results on the furnace function which results in the formation of rings inside the furnace and this accelerates the exchange process of the high temperature tolerance materials
6—In a case of use of solid fuel, air could be the only additive material to achieve enough temperature for a specific industrial field that works under 1000° C., for example, achieving the required temperature for the electricity generation for the production of fabrics.
However, in general; there are two types of additive materials to be added to the oil shale ash to produce the solid fuel, which are organic additive materials and inorganic additive materials.

### The Organic Additive Materials:

The organic additives are:
5—Coal: The coal can be synthesized by exposing it to crushing processes where the resulting fragments are the size of the oil shale fragments. The ash is mixed with low quality coal. The condition is that it is mixed well with the ash to guarantee combustion process, the amount of energy aimed to be achieved from this homogeneous mixture depends on the amount of air required to accomplish the combustion processes, and the speed of the air flow, as the combustion processes are increased in intensity when the air flow speed is higher which gives greater energy, this may not be appropriate in some of industries like the fabrics industry, water treatment, in addition to electricity generation, those industries in total require temperatures 350° C. to 650° C., and the produced vapor with its two forms (the regular and the heated) depends on the amount of energy required, there would be no need for excess.
6—The remnants of slaughter houses and specifically the organic remaining; in order not to need drying processes, stool needs to be separated from those remaining, the advantage of those additives is that it contributes to the generation of large amounts of energy that elevates the temperature for achieving the mining industries. The amount of energy generated depends on the amounts of additives to the ash.
   To obtain solid fuel, the ash is mixed with the residuals (remnants) of slaughter houses. In addition to a speed of the air of 80 m/s, it plays an important role in the combustion reaction and it is preferable to be a closed medium.
7—Peat: the remnants of Olives after extracting olive oil, where it undergoes drying and crushing processes, then mixed with oil shale ash, its particles are similar in size to the oil shale ash particles. To obtain solid fuel, the ash is mixed with the peat of olives residue. The amount of temperature that can be achieved contributes in obtaining a range of temperatures 110° C.-700° C., but here it is not dependent primarily on air, it depends on the air in the blowing processes into the combustion medium only to get rid of residues and gases resulting from the combustion. Good mixing process is taken into account.
8—Organic remnants from poultry houses: The remnants of the slaughtering, plucking, cutting and especially if these remnants contained heads, legs, skin and feather, the mixing is exceptionally important, second comes the air-amount and speed of air has to be gauged—the reaction medium closed, wrenching turbines very important, the amounts that achieve a temperature that reaches 3000° C. are (25-30) % but the amounts of energy resulting is very big. To obtain solid fuel, the ash is mixed with the organic remnants from poultry houses.
   Those additives can be made use of in the mining industries because it requires large amounts of high temperatures reaching above 2000° C.

It is important to emphasize that through the experience, it is found that the main role of the solid fuel is not for the additives; it is rather for the Calcinations process that the ash need to be exposed to before adding the additives which is concluded in the release of CO₂ from Lime stone to transform to live lime stone according to the following equation:

CaCO₃→CaO+CO₂

The calcinations process begins at the temperature of 900° C., the combustion gases inside the furnace carries CO₂ with it, which resulted from the disintegration of the Lime stone, this process lays the ground for the reaction of CaO with SiO₂ in the presence of Al₂O₃ and Fe₂O₃ and forms C₂S and C₃S in addition to C₃A and C₄AF as a step towards a combustion process that results in the formation of clinker where an appropriate additive is added then treatment processes are carried over that produces Cement that it is used in construction.

If it wasn't for the Calcinations process, the clinckerizing stage would not be reachable.

Not reaching the calcinations to its natural stage results in disruption of the functionality of the furnace, so the calcinations in general before entering the combustion area is very essential and cannot be discounted. This is necessary for burning the clinker well and in the right way to achieve high quality Cement.

If the goal was to achieve solid fuel with exceptional thermal content, and solid fuel remaining that is enough to cover the needs of Cement production then the additives fulfill the ideas that triggered the thought of solid fuel and the additives are then to make the remaining of the solid fuel is exactly the clinker.

### Inorganic Additive Materials:

To obtain solid fuel, ash is mixed with of various powdered metals such as Fe₂O₃ powder, Al powder, Zn powder, Sulfur powder, Ferrous powder, copper powder . . . etc. or any mixtures of them. The mixture is mixed very well to the point of complete blending:

The analysis on the samples exposed to treatment processes changes those percentages where the Cement standards require specific percentages of these materials, but a reaction between the oil shale and the blend releasing big amounts of energy that could elevate the temperature of the medium to 1500° C. without any external energy resource and under the condition of fulfilling the reaction medium.

### The Products of 1 Ton of Oil Shale Process:

When treating 1 ton of oil shale, the following products fulfills the law of conservation of mass and reflects the actual cost associated with this process, as for the additives, their percentages have already been highlighted, and it is originally available.

| | | | | Total thermal |
|---|---|---|---|---|
| | | | Thermal content | content for |
| Name of | Unit of | | per unit of | the extracted |
| Product | measure | Amount | measure -Kcal | amount-kcal |
| Oil Shale | m3 | 92-110 | 14800 | 1494800 |
| gas | | | | |
| Shale oil | Liter | 80-100 | 10500 | 945000 |
| solid fuel | Kg | 530-700 | 8000 | 4920000 |
| solid fuel | Kg | 420-580 | Industrial Use | — |
| residual | | | | |
| Water | Liter | 6-40 | Requires | — |
| | | | Purification | |
| Hot air | | Not | Total amount of | 7359800 |
| | | measured | temperature achieved | |
| | | | if the area of use is | |
| | | | Energy | |

The additives are related to the amount of energy it is aimed to achieve and the area of use on the remaining of solid fuel.

As result of the reactions that are all energy releasing, the clinker is formed.

After the cooling process it is pulled and mixed with small percentages of gypsum, the resulting powder is Cement. The amount of the combustion loss during the extraction and production of cement, and the combustion loss is very low in the formation of the cement from the remnants of solid fuel. Following table can be used for comparison.

| Name of Raw | CaO | SiO₂ | Al₂O₃ | Fe₂O₃ | MgO | Loss |
|---|---|---|---|---|---|---|
| material | (%) | (%) | (%) | (%) | (%) | (%) |
| Lime Stone | 52 | 5.7 | 0.8 | 0.3 | 0.4 | 40.4 |
| Shale | 3.2 | 53.8 | 18.9 | 7.7 | 2.2 | 13.1 |
| Sand | 0.8 | 70 | 15 | 5 | 0.2 | 8.6 |
| Clay | 0.5 | 41 | 16.9 | 12.4 | 0.4 | 7.8 |

After the calcinations process thermal reactions take place that releases energy and thus forming: C₄AF,C₃A,C₂S, and C₃S, the percentage of each compound is determined by the following formulas:

C₃S=4.07CaO−(7.6SiO₂+6.72Al₂O₃+1.43Fe₂O₃+2.65SO₃)

C₂S=2.83SiO₂−0.75C₃S

C₃A=2.65Al₂O₃−1.69Fe₂O₃

C₄AF=3.04Fe₂O₃

Looking at these criteria, the indicators to the additives amounts of the ash in order to transform it to solid fuel is seen.

The solid fuel residual can produce such good quality of clinker by adjusting the additive materials to the solid fuel in a way that performs the previous relations.

As for the interpretations of those compounds:

C₃S: responsible for the early growth of the mortar concrete, if the percentage of C₃S is increased above 65% it gets difficult to be burnt.

C₃A: Responsible for the ability of mortar formation by increasing its softness (the elastic cement is formed)

C₄AF: Is responsible of the color of the cement, the more the percentage is, the darker the color becomes. A light cement color is preferred, iron is liquidated material and can help in the formation of the previous compounds in lower temperatures than the in the previously mentioned.

In the research it is aimed to improve combustion processes, fighting pollution resulting from combustion processes and the extraction of industrial raw materials processes in a random manner, the use of solid fuel in combustion processes, savings of amounts of air and water, decreasing costs (high chimneys, electrostatic precipitators, polluting gas separation, and smoke wash).

When the solid fuel is dried and then powdered as the particle size less than 200 μm; then its ignition temperature can be as low as 100° C. Accordingly when designing the reactor and furnace; the particle size of the fuel is considered as key factor.

Reactions taking place inside the furnace:
Carbon combustion reaction:
The organic carbon remaining from the treatment of oil shale, and the inorganic carbon that is a component in the different raw materials of oil shale is distinguished.
A test to determine the percent of total carbon and a test to determine the percent of organic carbon are carried over, and there are ways to calculate the percent of inorganic carbon.
In a suitable reaction medium carbon is burnt in an oxygen rich environment, where CO₂ is released, but in the case of limited amount of oxygen CO is released, an energy releasing temperature.
Silicon combustion reaction:
In a suitable reaction medium Silicon is burnt in an oxygen rich environment, an energy releasing reaction, the enthalpy ΔH=910 kg/mol, double the enthalpy for carbon combustion.
The reaction of Fe₂O₃ powder with Al powder:
The temperature resulting from this reaction is enough to melt formed iron, this reaction is used in the iron fragments welding processes.
Aluminum powder reaction with Sulfur:
In a suitable reaction medium a strong reaction takes place releasing very large amount of energy.
Zn combustion reaction:
In a suitable reaction medium and presence of oxygen, Zn is burnt, releasing large amounts of energy.
Reaction of Zn powder with Sulfur:
In a suitable medium, the mixture is burnt, and the reaction releases very large amounts of energy.
Reaction of Iron powder with Sulfur:
In a suitable reaction medium a string reaction takes place; releasing very large amounts of energy.
(Reaction medium means the combustion furnace, where the solid fuel is thrown (ash+additives) in a temperature that starts at 650 C).
Calcinations reaction:
Starts with the disintegration of CaCO₃ and the release of CO₂, where it is impossible for the combustion reactions to take place (clinker producing consists). If the calcinations is not completely performed, this is very important and without it; the combustion reactions cannot be correctly performed.
Formation of C₂S and C₃S reactions:
These reactions require high temperatures, accompanied by the disappearance of Calcium, and the formation of C₂S and C₃S and this takes place at the sintering temperature.
Combustion reaction and the formation of clinker:
Reactions resulting in the formation of C₄AF and C₃A, that react with C₃S and C₂S which needs a temperature higher than C₃S that reaches 1450 C, the combustion process is what achieves a good quality clinker.
Iron Pyrite reaction with copper in the presence of quartz:
Reactions that release large amounts of energy and do not need an external energy source in the presence of oxygen.

### Main Combustible Elements in the Solid Fuel:

There two main elements: Carbon and Silicon, which lay the base for the combustion in the solid fuel. Those two elements are characterized by the presence of four electrons on the last energy level, the Ionization energy is related to the atomic size, as it differs between two of them, those factors make the oxides of those elements to be oxides acidic.

| | | | | | | | Ionization | | Electro | | | |
|---|---|---|---|---|---|---|---|---|---|---|---|---|
| | | | | | | | energies | | negativity | | Enthalpy of | |
| | Atomic | Outer | Atomic | Density | M.P | b.p | (kJ) | | (Pauling) | | atomization | |
| Element | No. | electrons | Radius (nm) | at 298 k | (k) | (k) | 1^{st} | 2nd | 3^{rd} | 4th | (kJ/mol) | |
| C | 6 | 2S²2P² | 0.077 | 2.25 | 3823 | 5100 | 1086 | 2353 | 4618 | 6512 | 2.5 | 417 |
| Si | 14 | 3S²3P² | 0.118 | 2.33 | 1683 | 2950 | 786 | 1577 | 3228 | 4355 | 1.8 | 440 |

Crystal Silicon has the shape of the tetrahedral diamond but the intensity of the thermal chemical bond between silicon atoms is less than that between carbon atoms

Si—Si=226 K·J/mol

C—C=356 K·J/mol

So the silicon does not possess the solidity of the diamond, and the noncrystallized silicon is a microcrystal powder.

Carbon and Silicon are not affected by diluted acids, the first reacts with bases, the second reacts with diluted bases.

If carbon in heated sufficiently in the presence of Oxygen, it gives CO₂, small amounts of oxygen gives CO.

C+O₂→CO₂ΔH=−391 K·j·mol⁻¹

C+½O→COΔH=−11 K·j·mol⁻¹

Silicon is heated in the air till reaching the temperature that the silicon becomes red in color:

Si+O₂SiO₂→ΔH=−910 K·g·mol⁻¹

It can be seen that the enthalpy for SiO₂ is greater than that for CO₂ because Si—O=452 K·j·mol⁻¹ and C—O=358 Kj·mol⁻¹.

Carbon Hydrates: there are two types of hydrates, a straight chain and closed chain; the two types are also consistent with two saturated hydrocarbon compound models, and unsaturated hydrocarbon compounds.

The numbers of carbon hydrates are many and various

Their model is: CHₙH₂ₙ₊₂

The number of Silicon hydrates is limited and the volatile hydrate chain of the covalent bonds called “Silanes” that is similar to hydrocarbons, its general formula is: Sin H₂ₙ+2.

The self-adhesion phenomenon between the element's self-atoms is less important in the silicon compared to the carbon, and high silanes disintegrates slowly in high temperatures, and its sensitivity to oxygen becomes greater than its sensitivity to alkanes, additionally all silanes self-ignites in the air automatically as shown below:

CH₄+2O₂→CO₂+2H₂O

SiH₄+2O₂→SiO₂+2H₂O

When heating the silica to high temperatures and under fluctuating pressure SiO is formed in its metal form, by cooling a brownish powder is obtained that oxidizes and self-reduced according to the following equation:

2SiO→Si+SiO₂

Si is a combustible element just like the carbon but its combustion reaction releases more energy than the carbon's.

When thinking of a mechanism of the silica existence in the nature and discussed ways of burning it to calculate the amount of the thermal energy released by burning it and compared it to carbon. The silica exists in nature in many crystal shapes mainly: kierelguhr, cristobalite, tridymite and quartz.

The solid crystallized aqua material had great ability of absorption and so its shapes are great particles where each silicon atom is linked to four oxygen atoms and appears in a tetrahedral shape, as follows:

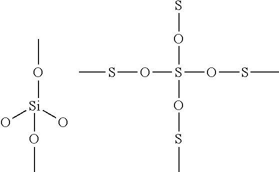

Silicon can be obtained in pure form by decomposition tetrafluoride silicon or tetrachloride silicon, and then immediately have it burnt by adjuvant combustion material such as the hydrogen. The Silicon atoms can carry two sets of hydroxide which is unlike the carbon atom, so, by changing the compounds and the hydrolysis conditions; the straight chains, annular and the polymers are obtained to connect these Alsellkonat which have similar behavior of hydrocarbon. Moreover, the correlation and bond length enable the presence of silicon in term of oils form that are characterized by its stability under high temperatures, which enable it to be used as lubricants at low temperatures because the hydrocarbon lubricants' viscosity increases with the decrease of the temperature. Accordingly, the Silicon is regarded as water repellent material with High Isolation factor. It is noted when reviewing the information that the silicon is approaching a large degree of a carbon which is a combustible material in certain conditions.

Since the reaction medium is a high temperature furnace at the presence of strong airflow, and in addition to the presence of carbon as a catalyst; the combustible silicon ignites at a good degree, As a result, oxygen plays a key role in all components of the combustion of oil shale ash as well as additive materials which are inherently incombustible materials.

In the big industrial fields, relying on adding lime coal only even if it had low thermal content is possible.

An experiment was performed over the Turkish oil shale with the content of 1800 Kcal/kg, moisture of 8%, and Sulfur of 0.9%; the results of the analysis of this processing operations for the oil shale were as shown in the table below:

| | |
|---|---|
| CaO | 23.27% |
| SiO₂ | 42.24% |
| Al₂O₃ | 17.34% |
| Fe₂O₃ | 7.40% |
| MgO | 2.94% |

When the goals are to achieve solid fuel with high thermal content, clean combustion, large amounts of thermal energy and reasonable prices; then the mixture is linked to the importance of the solid fuel residual. If the main goal is to produce cement through the analysis which has been performed over the oil shale ash and the coal ash; the mixture consists of all the main materials for cement productions, which are resulting from the process of burning the mixture.

Accordingly it is confirmed that the oil shale treatment project is an energy production project, clinker and cement production project.

Coal: Combustible rock formed from the remnants of plants decomposition, its color is black or dark brown. The percent of carbon is 60% to 90% and this percentage depends on the degree of the coal roasting level.

The coal is considered as the most difficult for use among all kinds of fossil fuels due to the difficulty of the mining works and the environmental conditions related to its combustion.

The chemical composition of coal, carbon-hydrogen-oxygen, bonding with chemical reactions as main material resulting from photosynthesis in addition to additions form Nitrogen, chloride, sulfur and remaining of metallic elements.

The degree of coal/roasting is the standard for the percentages of the substances comprising the coal and CH₄ are the associated gas for these reactions, they have to be rid of because of their harmful effects, resulting to obtaining the brown low quality coal, low in thermal content and low percentages of volatile matters.

The black coal(Antracite)-high quality-high thermal content, the volatile matter and impurities determines its uses.

The high thermal content of the coal encouraged the Chinese company (Foushon) to introduce coal to the oil shale during the treatment processes to make use of its thermal energy during the heating processes.

When the coal is used with suitable amounts to the combustion processes, many factors should be taken into account such as knowing the carbon which determines the amount of air required for combustion.

Moist contributes to decreasing the thermal value because of the capillary action coal absorbs moisture, the Sulfur's percent is 0.5%-5%, which is related to the pollution and erosion of the container.

Ash: the incombustible material and represents the debris that was found in the mud that the plant material was roasted in.

The oxygen: its percentage decreases with the increase of the roasting level, as the increases in its percentage results to the decrease of its use.

### Research and Development:

Aims at replacing petroleum derivatives with coal derivatives; this encourages the extraction of gas from coal, with less cost than extracting petroleum derivatives from coal.

Research on Germany succeeded some accomplishments, other research in USA and UK in the area of transforming coal to gas and even coal liquidation, large credits were dedicated to these researches.

Coal gasification: Process of transforming coal to gas fuel, and so the idea of Synthetic natural gas aroused, but this idea will not be successful with the evolution of a new culture that depends on coal as an additive rather than a combustion material.

Coal liquidation: Process of transforming coal to liquid hydrocarbon fuel, and depends on decreasing the percent of carbon and increasing the percent of hydrogen, either by hydrogenation, or elimination of some carbon atoms, by producing coal or CO gas, all these ideas remained not applicable due to its high cost and large energy requirements.

The scientific efforts are focusing on supporting the research of the following cases:
5. Coal Hydrogenation in high pressure medium.
6. Pyrolysis.
7. Coal disintegration using petroleum dissolvent.
8. Improving produced gases from the coal.

These efforts were not successful because it did not prove its self in the discovery stages, and here it is mentioned that the research and development is only applied over successful ideas, for example when it is desired to stop the random use of energy; and to stop the chaotic production of cement; why large amounts of energy is used without previously studying it.

So when the oil shale treatment project is considered; it is confirmed that the needs for gas and oil are linked to the needs to the cement. All this is apparent in a comprehensive project that provides raw materials, energy, and water.

Accordingly, separate cement factories are not needed which is reflected on the economical aspect of the project and fulfills suitable conditions for earth stability.

In WO 2010/034621 a thermal dismantling method which produces product vapours which are separated by distillation, yielding shale gas, shale oil, water is disclosed. In our present invention; all the organic materials are vapored at the degree of 950 C, so, the remaining ash is totally free from any organic materials, and accordingly, it could not be coke. Moreover, our solid fuel is mixed up with different external additives.

Regarding adding the Oxygen to the combustion process, we agree that it is well known for the skilled person, but we managed to find the relation between the amount of the added Oxygen and the desired temperature with and without the external additives.

Regarding claim 2 of the present invention, the additives used in WO 2010/034621 A1 are just the petrol, water and coke gas which are all organic materials where in the present invention there are more added materials in term of organic and/or non-organic.

As a results to the added organic or/and non-organic materials, the present invention controls the desired temperature and the use of the residual ash resulted from burning the solid fuel.

Regarding to Claim 3 of the present invention, WO 2010/034621 A1 added organic materials which are all resulting from the dismantling processes, while in the present invention; the added organic materials could be any organic materials from outside the dismantling unit such as the poultry residuals, peat . . . etc. Accordingly the solid fuel that includes 0% of organic materials is being taken out of the reactor to be cooled and then treated to be used again in the furnace to treat the new oil shale.

Regarding Claims 4 and 5 of the present invention; WO 2010/034621 A1 does not mention adding any extra additives other than water and coke gas and petrol, whereas in the present invention many organic and/or non-organic additives are added with the specific percentage for each added material.

Regarding the ignition temperature of 150° C. to 720° C. in WO 2010/034621 A1, WO 2010/034621 A1 mentioned the temperature related to the added Oxygen rate. In the present invention the method of using temporary igniter works with liquid or gas fuel till reaching the temperature of 550° C. or above.

In U.S. Pat. No. 4,886,521, the added Fe₂O₃ is mixed with the oil shale in a gaseous atmosphere. In the present invention; the added Fe₂O₃ is mixed with the oil shale ASH, which is totally organic free due to heating the oil shale to the temperature of up to 1000° C. and then Fe₂O₃ is used with other elements that their reactions release the heat energy as illustrated in the chemical reaction equations in the description and claims. Moreover an igniter is used to reach the temperature of above 550° C. for starting the burning process without the need of the gaseous atmosphere. Accordingly, the present invention does not need gaseous atmosphere and it works with the oil shale ash after extracting the whole organic material rather than burning it in the heating processes.

In IL 102275 A, adding rubbers to the oil shale to extract shale oil, shale gas and solid fuel is performed over the oil shale while in the present invention; the additives are added to the oil shale ash which is %100 free of organic materials. Moreover, in the present invention; many other additives are added so, all other comments for WO 2010/034621 A1 are valid for IL 102275 A.

In CN 1453344 A, a combustion method of solid fossil fuel is disclosed. According to the disclosure, oil shale carbocoal waste in 60-100 weight % and oil shale screenings in 0-40 wt % are mixed, crushed and burnt in circular fluidized bed boiler at low temperature of 850-950° C.

In the present invention; oil shale ash which is %100 organic free is mixed with different additives to be used as solid fuel. So, all the comments for WO 2010/034621 A1 are valid for CN 1453344 A.

Finally, the temperature range obtained in CN 1453344 after burning it in fluidized bed boiler is in between 850 to 950° C. while in the present invention, the temperature after burning can reach up to 3500° C.

In EP 0107477 A1, the residual depleted shale is regarded as solid fuel and then get bunt to produce steam and heating fresh oil shale, in the present invention; oil shale ash which is %100 organic free is mixed with different additives and then burned. So, all the comments for WO 2010/034621 A1 are valid for EP 0107477 A1, in addition, in the present invention the solid fuel can be used as heat source for outside of the dismantling unit which is unlike EP 0107477 A1 where the heat is just being used to heat the new fresh oil shale and to produce the steam.

In DE 3916597, residues from processing of cattle or pig manure are eliminated by mixing the residues with lignite dust and/or coal dust, to render the material inert and reduce NOX due to the NH3 content, with production of a non-polluting coal product. At the same time, components binding SO2, HCl and HF may be added, e.g. lime (CaO, Ca(OH)2, CaCO3) or waste lime from sugar beet production. USE/ADVANTAGE—The product is used as fuel in heating and power stations. Addition of the residue to the dust renders it inert and reduces the risk of explosion.

In the document WO 2010/066316 A1, a process for producing cement or cement substitutes on the basis of carbon-containing compounds, wherein the carbon-containing compounds are burnt in a furnace at a temperature of 600 to 900° C. is disclosed. In the present invention the non-carbon compounded materials are obtained from the oil shale by burning it at a temperature between 850-1000° C. where no any organic materials remains in the oil shale ash which carbon free oil shale ash. The oil shale ash that does not contain any carbon is then mixed up with the proposed additives by excluding the coke.

Document CN 102875184 A provides an aerated brick made from oil shale residue. The compound of making it comprises, besides inorganic and organic additives, Al-powder. In D9, the method of producing the bricks using the oil shale and oil shale ash is disclosed. In the present invention the non-carbon compounded materials are obtained from the oil shale by burning it at a temperature between 850-1000° C. where no any organic materials remains in the oil shale ash which carbon free oil shale ash.

In EP 0727398 A2, a composite cement, which hardens and develops full strength rapidly, which contains calcined oil shale, cement clinker, calcium sulpho-aluminate, anhydrous calcium sulphate and water-reducing agent is disclosed. Comments mentioned in WO 2010/066316 A1 are valid for EP 0727398 A2.

The document U.S. Pat. No. 3,972,724 relates to burning fuel shale to produce cement clinker and energy at the same time Comments mentioned in WO 2010/066316 A1 and D9 are valid for US 3972724 A.

CN 101143766 discloses an oil shale based porous adiabatic construction material for construction of wall and roof, which comprises a preset amount of oil shale as basic component, burnable additive, oxide and intensifier. Comments mentioned in WO 2010/066316 A1 and D9 are valid for CN 101143766 A.

JP 588538 describes that spent oil shale is supplied to an absorbing tower and contacted with the exhaust gas from a conduit to carry out wet desulfurization. In JP 588538 A, the tower is used to desulfurization, however, in the present invention, the produced active carbon is capable to be used in gas and liquid purification, filtering, adsorption and absorption. Moreover, the produced active carbon is obtained from the oil shale treatment at a temperature of 850-1000° C. where the organic materials are zero.

In U.S. Pat. No. 5,571,490 high sulphur content fuel is combusted in the presence of oil shale containing significant amounts of calcium carbonate so that the sulphur and calcium carbonate oxidize and react to form calcium sulphate particulate which captures the sulphur and in the fuel and prevents its release to the atmosphere.

In the document WO 2009/010157 a process and a plant for refining solids containing oil and/or bitumen, in particular oil sand or oil shale is disclosed.

In the document U.S. Pat. No. 4,054,482, “a dry distillation process for treating bituminous or oil-containing fine-grained material, particularly tar sand, with a heat carrier comprising fine-grained dry distillation residue which is heated in a pneumatic conveyor line by hot combustion gases and then fed to a collecting vessel and mixed in a dry distillation zone with the fine-grained material to be subjected to dry distillation” is disclosed.

In the document U.S. Pat. No. 3,972,724; a method of processing fuel shale to produce energy and cement clinker at the same time, oil shale and/or coal shale are disintegrated, homogenized and activated in a pin beater mill or vibrating mill. The effect of the treatment is monitored by X-ray microanalysis and the treatment is automatically controlled. The admixtures required for the production of a cement having the desired quality are added simultaneously at controlled rates. The thus treated material is then burnt in a boiler plant, preferably at combustion temperatures up to 1400° C. and with simultaneous sintering, whereby ash and/or slag is formed which contains at least 60% cement clinker. Said cement clinker is separated from the residual ash and slag and in an impact-type mill is disintegrated in such a manner that each clinker particle is subjected to 3-8 impacts within a time of preferably less than 0.01 second by beating elements which are moved at a velocity of at least 15 meters per second, preferably at a velocity between 50 meters and 250 meters per second.

### SUMMARY OF THE INVENTION

in the present invention, ash is defined as spent shale, ash obtained by high temperature oil shale dismantling process, treated spent shale, ash obtained from direct burning of oil shale, ash obtained from indirect burning of oil shale or any mix of them. It is used as the main component of solid fuel.

In order to burn this ash which is the main component of the solid fuel with or without additives, at least 5 m/s of air flow is needed. Oxygen may be added to improve burning. Additionally the temperature needed to ignite the burning is more than 300° C. After the ignition; the burning starts and the furnace temperature gradually increases. The furnace temperature can reach up to 3500° C. by control of air and/or flow and the additives. Oxygen may be added to improve burning.

In the mixtures in this invention the percentages are given by weight of the ingredients of the mixture.

The calorific values for presently used energy sources and ash to be used in production of solid fuel are in the below Table.

| Calorific Value for Presently used | | |
|---|---|---|
| Energy Sources and Ash to be used | | |
| in production of solid fuel (kcal/kg) | | Comments |
| Dry Gas | 9000 to 10000 | |
| | kcal/kg | |
| Wet Gas | 11000 to 15000 | |
| | kcal/kg | |
| Crude Oil | 9000 to 11000 | |
| | kcal/kg | |
| Fuel Oil | 10000 to 10900 | |
| | kcal/kg | |
| Ash which is spent shale, | 250 to 6000 | If the ash is burned in a |
| ash obtained by high | kcal/kg | proper environment |
| temperature oil shale | | with a required amount |
| dismantling process, treated | | of air oxygen when |
| spent shale, ash obtained | | necessary the calorific |
| from direct burning of oil | | value increases up to |
| shale, ash obtained from | | 6000 kcal/kg. |
| indirect burning of oil | | Otherwise the calorific |
| shale or any mix of them | | value is low |

Types of additives to ash, their percentages and calorific values and the calorific value of the produced solid fuel are in the below Table.

| | Calorific Value | Additive | Calorific Value of |
|---|---|---|---|
| Type of additives to | of Additives | Percentage | Produced Solid Fuel |
| the ash | (kcal/kg) | (%) | (kcal/kg) |
| Coal | 5500 to 7800 | 20 to 30 | 8500 |
| Peat | 3500 to 4000 | 30 to 35 | 8500 |
| Slaughter House | 3800 to 5000 | 25 to 30 | 8600 |
| Material | | | |
| Poultry Material | 4000 to 6000 | 30 to 35 | 9600 |
| Wood Coal | 3400 to 4200 | 20 to 30 | 5800 |
| Torp Coal | 3300 to 4000 | 25 to 30 | 6800 |
| Lignite Coal | 5500 to 6500 | 20 to 25 | 7500 |
| Al + Fe₂O₃ | 4900 to 5600 | 1 to 13 | 9400 |
| Zn + O | 3200 to 4000 | 6 to 14 | 7500 |
| Al + Cu + Fe + S | 6000 to 9000 | 8 to 12 | 11000 |
| Al + S | 3800 to 4700 | 10 to 12 | 7900 |
| Zn + S | 3900 to 5000 | 9 to 11 | 7400 |
| Fe + S | 4000 to 5600 | 10 to 12 | 8100 |
| Coal + Fe + Al + S | 6000 to 8000 | 5 to 15 | 10000 |
| Slaughter House | 5800 to 7900 | 7 to 13 | 9800 |
| Material + Fe + Cu | | | |
| Peat + Al + Fe | 5500 to 6400 | 6 to 14 | 9000 |
| Poultry Material + | 6000 to 8000 | 10 to 12 | 10500 |
| Al + Fe + Cu | | | |

### BRIEF DESCRIPTION OF THE DRAWINGS

FIG. 1 shows the calorific values of the solid fuel with organic or inorganic or coal additives.

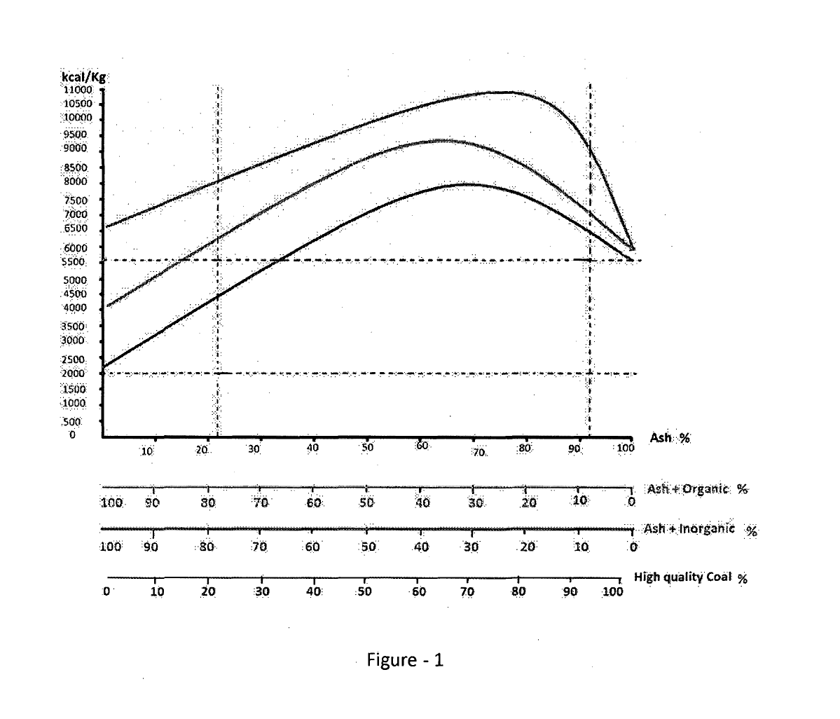

FIG. 2 shows the calorific values of the solid fuel with organic and inorganic additives.

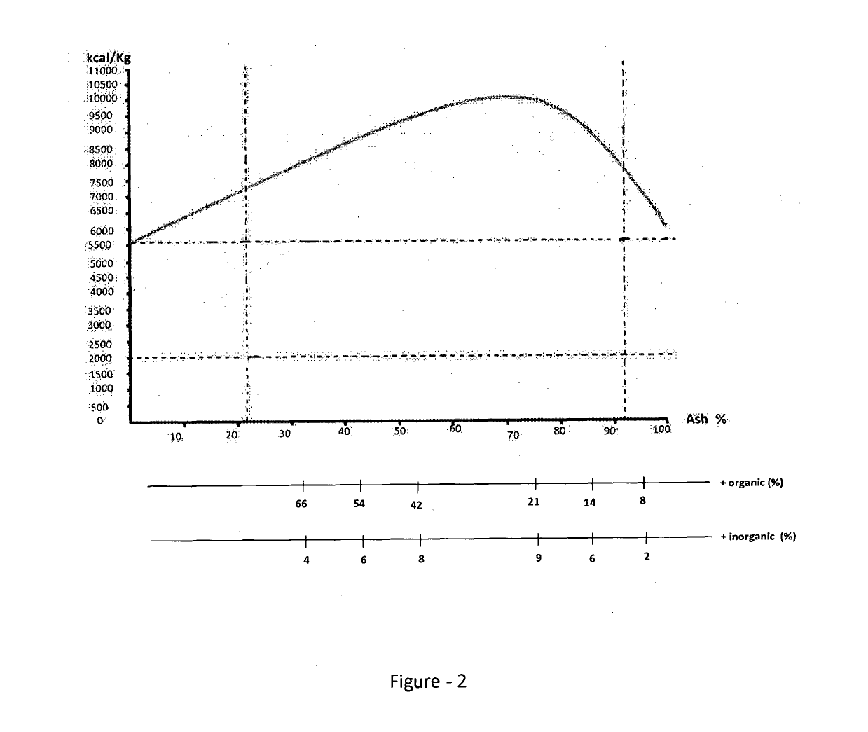

### DETAILED DESCRIPTION OF THE INVENTION

In the present invention, spent shale means the ash obtained after the presently used oil shale dismantling methods and has organic materials inside.

In the present invention, ash means the ash obtained by the high temperature oil shale dismantling method and has no organic material inside.

The present invention claims; use of spent shale obtained after the presently used oil shale dismantling methods or ash obtained by the high temperature oil shale dismantling method as solid fuel.

In the present invention, the solid fuel may also be the mixture of 1% to 100% of ash which is spent shale, ash obtained by high temperature oil shale dismantling process, treated spent shale, ash obtained from direct burning of oil shale, ash obtained from indirect burning of oil shale or any mix of them, with 0% to 99% of organic and/or inorganic additives or any mixture of organic and inorganic additives.

The ash without any additives can be used as solid fuel. Solid fuel can also be produced by mixing 30% to 90% of ash with 10% to 70% of organic or inorganic additives or any mixture of them.

In order to produce solid fuel, 30% to 90% of ash is mixed with 10% to 70% of organic additives. These organic additives are organic creatures. The residuals of slaughter houses or organic remnants from poultry houses peat, cellulose, viscose, acrylic, plastic or peat of olives residue can be used as organic additives or any mix of them.

As an alternative, in order to produce solid fuel, 30% to 90% of ash is mixed with 10% to 70% of inorganic additives. These inorganic additives are one or more various powdered metals. Any combination of two or more of Fe₂O₃ powder, Al powder, Zn powder, sulfur powder, ferrous powder or cupper powder can be used as inorganic additives.

In order to produce solid fuel, 1% to 5% of Sulfur is mixed to 95% to 99% of solid fuel which is produced by any one of the abovementioned processes.

Clinker which is the main component of cement can also be produced by the present invention. In order to produce clinker, 50% to 100% of ash is mixed with 0% to 50% of low quality coal and/or inorganic additives and/or organic or inorganic additives or any mix of them and then the mixture is burned again in the furnace at the temperature of 650° C. to 3500° C. by feeding air with the speed of above 5 m/s. Oxygen may be added to improve the burning. The ash (residue) of this burning is clinker. It can be used in producing cement. However, the best quality of clinker can be produced after burning the mixture of 75% ash with 25% of low quality coal.

Another product, raw material for manufacturing thermal isolation (insulation) materials that can be used in construction of furnaces or isolation materials in construction industry can also be produced by the present invention. In order to obtain raw material for manufacturing thermal isolation (insulation) materials, 40% to 100% of ash is mixed with 0% to 60% of various powdered metal and/or coal or any mix of them, and then the mixture is burned in the furnace at the temperature of 650° C. to 3500° C. by feeding air with the speed of above 5 m/s and raw material for manufacturing thermal isolation (insulation) materials are obtained. In order to use this ash as raw material for manufacturing thermal insulation materials, the ash is grinded and used as the main element of manufacturing the thermal insulation materials. Oxygen may be added to improve the burning. However, the best quality of raw material for manufacturing thermal isolation (insulation) materials can be produced by mixing 85% of ash with 15% of various powdered metal.

Method for producing raw material for manufacturing thermal isolation (insulation) materials that can be used in construction of furnaces or isolation materials in construction industry, Fe₂O₃ powder, Al powder, Zn powder, sulfur powder, Ferrous powder or copper powder can be used as powdered metals.

Another product, raw material for manufacturing brick blocks as construction materials can also be produced by this invention. In order to obtain construction materials to produce brick blocks 30% to 100% of ash is mixed with 0% to 70% of organic and/or inorganic and/or coal or any mix of them, and then the mixture is burned in the furnace at the temperature of 650° C. to 3500° C. by feeding air with the speed of above of 5 m/s, the ash from the furnace is grinded to be used raw material for manufacturing brick blocks by the presently used methods. Oxygen may be added to improve the burning. However, the best quality of raw material for manufacturing brick blocks can be produced by mixing 85% of ash with 15% of various powdered metals.

The organic materials are the organic creatures such as peat of olives residue or the residuals of slaughter houses or organic remnants from poultry houses peat, cellulose, viscose, acrylic or plastic . . . etc.

Another product, raw material for manufacturing pavement blocks can also be produced by this invention. In order to obtain pavement blocks, 30% to 100% of ash is mixed with 0% to 70% of organic creatures and/or various powdered metals and/or coal or any mix of them and then the mixture is burned in the furnace at the temperature of 650° C. to 3500° C. by feeding air with the speed of above of 5 m/s, the ash from the furnace is grinded to be used raw material for manufacturing pavement blocks by the presently used methods. Oxygen may be added to improve the burning. However, the best quality of raw material for manufacturing pavement blocks can be produced by mixing 95% of ash with 5% of various powdered metal

In order to obtain pavement blocks Fe₂O₃ powder, Al powder, Zn powder, sulfur powder, ferrous powder or copper powder can be used as powdered metals.

The ash which is spent shale, ash obtained by high temperature oil shale dismantling process, treated spent shale, ash obtained from direct burning of oil shale, ash obtained from indirect burning of oil shale or any mix of them can be treated to be 100% free from organic materials; that can be used in grinded form as active carbon for the purpose of purification, filtering and adsorption and absorption of liquids and gases. The particle size of the ash after grinding for liquid purification is in between 8 to 40 μm. The particle size of the ash after grinding for gas purification is in between 4 to 10 μm.
High temperature achievement mechanism is explained below.
The idea behind burning the advanced solid fuel system is derived from the knowledge of the series of the successive thermal interactions that occur on the surface of the stars and its mass limitation and the stages of its life cycle. Adequate knowledge of these concepts leads to understanding the difference between chemical energy and nuclear energy.
The chemical energy is often stored inside the material and contributes to the process of binding the atoms in the molecule, as well as binding the material's molecules together. Chemical energy often turns into thermal energy through chemical reactions.
The nuclear energy is initiated from the atom of the nucleus as a result of the nuclear particles' rearrangement and assembling. This is accompanied with a transfer of parts of the mass of these particles into energy.
The temperature raising mechanism from nuclear energy is explained below.
The amount of transformed amount of mass into energy is a key factor in the process of temperature control that can be achieved within the reaction medium.
The atom is the essence of the material's structure, and energy is considered as the engine of this essence which indicates a complementary relationship between the material and energy. From here, it can be concluded that the mass of the nucleus is the main criteria for the material's energy content.
As the mass of the nucleus is less than the sum of its components' masses: the shortfall in the nucleus mass is regarded as an indicator to the correlation energy between the components of the nucleus. The correlation energy between the nucleus components can be calculated with the Lahnstein Law bellow:

ΔE=ΔMC²
Where ΔE is the change in the amount of the correlation energy, ΔM is the change in the nucleus mass and C is the speed of light.
The temperature raising mechanism from the chemical interaction energy is explained below.
In this field; the advantage of the chemical interactions must be taken to obtain the thermal energy.
The chemical reactions take place between the reactants in large amounts and it needs so-called activation energy to occur. Activation energy can be obtained from various sources such as heat to speed up the movement of the atoms and molecules. Chemical interactions release thermal energy by means of heat. The resulting heat is calculated based on the amounts of the reactants.
Nuclear reactions: in which a nucleus interacts with other nucleus or nucleolus (proton or neutron). The interaction occurs in a very short period of time in order to produce a new nucleus or more. The resulting interaction is associated with releasing small particles and energy.
When the interaction energy is calculated on the basis of grams rather than the interaction of the nucleus; the amount of the released energy would be enormous.
These facts make the interaction approach nuclear reactions that make the thermal reaction medium achieve high temperatures. The resulting high temperatures contribute to the occurrence of new series of successive thermal interactions, as a result; the reaction medium temperatures could achieve the temperatures of up to a level that is similar to the surface temperature of the stars, and this medium is suitable for the continuation of the thermal nuclear reactions.
In conclusion; energy can be obtained either from the nuclear energy stored in the nucleus mass according to Lahnstein Law in terms of correlation energy, or from the chemical interactions energy which is stored in the bonds.
To process oil shale; it is enough to reach the temperature of 1600° C. at the center of the combustion reaction medium and 1000° C. at the reactor's wall.
If the propose from using the combustion system (combustion medium) is to access high temperatures that meet the requirements of the mining industry (starts from temperatures of 2000° C. and above); it is enough to change the reaction medium (reactor liner material) and to increase the amount of the material that is used to be changed into energy (achieving what is happening on the surface of the stars). Accordingly; the more the amount of material transformed into energy is increased; the higher the temperature of the reaction medium is achieved.
In conclusion; the high temperatures are obtained by taking advantage of the nature of chemical reactions at first, as well as the nature of the interactions of thermal nuclear secondly. This underlines the amount of benefit achieved from the potential energy stored in the advanced solid fuel to reach such high temperatures.
Since all types of rocks consist of eight key elements in addition to no more than 2% of different secondary elements; all of these elements are considered as combustible in presence of oxygen or the presence of a sufficient amount of air.
The existence of the above mentioned scientific facts and the implementation of the well-studied calculations; temperatures that contribute in melting and evaporating metals can be obtained, taking into consideration that reaching the desired high temperature relies on the combustion medium that can bear that temperature without reaching the state of collapse. Thus, any high temperature can be accessed provided that the combustion medium that can stand this temperature exists.

1- A solid fuel characterized in that,
it comprises spent shale ash or oil shale ash which is obtained by dismantling process at the temperature of 850-1000° C. till releasing all the organic materials, and
it is burned under two steps of burning, wherein the first step is heating the environment up to 550° C. by using any solid, liquid, or gas fuel, and the second step is replacing the fuel in the first step by the solid fuel comprising spent shale ash or oil shale ash which is obtained by dismantling process at the temperature of 850-1000° C. till releasing all the organic materials.

2- The solid fuel as claimed in claim 1 and characterized in that 1% to 100% of the solid fuel is mixed with 0% to 99% of organic and/or inorganic additives or any mixture of organic and inorganic additives

3- The solid fuel as claimed in claim 1 and characterized in that 30% to 90% of the solid fuel is mixed with 10% to 70% of organic and/or inorganic additives or any mixture of organic and inorganic additives.

4- The solid fuel as claimed in claim 1 and characterized in that 30% to 90% of the solid fuel is mixed with 10% to 70% of organic additives.

5- The solid fuel as claimed in claim 1, 2, 3 or 4 and characterized in that organic additives are any organic creatures.

6- The solid fuel as claimed in claim 5 and characterized in that organic additives are residuals of slaughter houses or organic remnants from poultry houses, cellulose, viscose, acrylic, plastic or peat of olives residue or any mix of them.

7- The solid fuel as claimed in claim 1 and characterized in that 30% to 90% of the solid fuel is mixed with 10% to 70% of inorganic additives.

8- The solid fuel as claimed in claim 1, 2, 3 or 7 and characterized in that inorganic additives are one or more powder materials selected from Fe₂O₃ powder, Al powder, Zn powder, sulfur powder, ferrous powder or cupper powder.

9- The solid fuel as claimed in any one of the preceding claims and characterized in that 1% to 5% of sulfur is mixed to 95% to 99% of solid fuel.

10- Method for producing clinker characterized in that 85% to 99% of ash which is spent shale ash or oil shale ash which is obtained by dismantling process at the temperature of 850-1000° C. till releasing all the organic materials, is mixed with 1% to 15% of inorganic additives, and then the mixture is burned again in the furnace at the temperature of 550° C. to 3500° C.

11- Method for producing raw material for manufacturing thermal isolation (insulation) materials characterized in that 88% to 99% of ash which is spent shale ash or oil shale ash which is obtained by dismantling process at the temperature of 850-1000° C. till releasing all the organic materials is mixed with 1% to 12% of inorganic materials, and then the mixture is burned in the furnace at the temperature of 550° C. to 3500° C. and then the ash is grinded to be used of manufacturing the thermal insulation materials.

12- Method for producing high quality raw material for manufacturing thermal insulation materials characterized in that 88% to 99% of ash which is spent shale ash or oil shale ash which is obtained by dismantling process at the temperature of 850-1000° C. till releasing all the organic materials is mixed with 1% to 12% of inorganic materials.

13- Method for producing raw material for manufacturing thermal isolation (insulation) material as claimed in claim 11 or 12 characterized in that inorganic additives are one or more powder materials selected from Fe₂O₃ powder, Al powder, Zn powder, sulfur powder, ferrous powder or cupper powder.

14- Method for producing raw material for manufacturing brick blocks as construction materials characterized in that 30% to 100% of ash which is spent shale ash or oil shale ash which is obtained by dismantling process at the temperature of 850-1000° C. till releasing all the organic materials is mixed with 0% to 70% of organic and/or inorganic and/or coal or any mix of them, and then the mixture is burned in the furnace at the temperature of 550° C. to 3500° C. and then the ash from the furnace is grinded to be used as raw material for manufacturing brick blocks.

15- Method for producing high quality raw material for manufacturing brick blocks as construction materials characterized in that 85% of ash which is spent shale ash or oil shale ash which is obtained by dismantling process at the temperature of 850-1000° C. till releasing all the organic materials is mixed with 15% of various powdered metals.

16- Method for producing raw material for manufacturing brick blocks as construction materials as claimed in claims 14 and 15 and characterized in that organic materials are the organic creatures such as peat of olives residue or the residuals of slaughter houses or organic remnants from poultry houses, peat, cellulose, viscose, acrylic, plastic.

17- Method for producing raw material for manufacturing pavement blocks characterized in that 30% to 100% of ash which is spent shale ash or oil shale ash which is obtained by dismantling process at the temperature of 850-1000° C. till releasing all the organic materials is mixed with 0% to 70% of organic creatures and/or various powdered metals and/coal or any mix of them and then the mixture is burned in the furnace at the temperature of 550° C. to 3500° C. by feeding air with the speed of from above of 5 m/s, the ash from the furnace is grinded to be used raw material for manufacturing pavement blocks.

18- Method for producing high quality of raw material for manufacturing pavement blocks characterized in that 95% of ash which is spent shale ash or oil shale ash which is obtained by dismantling process at the temperature of 850-1000° C. till releasing all the organic materials is mixed with 5% of various powdered metal.

19- Method for producing raw material for manufacturing pavement blocks as claimed in claims 17 and 18 and characterized in that powdered metals are Fe₂O₃ powder, Al powder, Zn powder, sulfur powder, ferrous powder or copper powder.

20- Use of the ash which is spent shale ash or oil shale ash which is obtained by dismantling process at the temperature of 850-1000° C. till releasing all the organic materials for purification, filtering, adsorption and absorption of liquids and gases.

21- Use of the ash by grinding as powder form with particle size being less than 40 μm. which is spent shale ash or oil shale ash which is obtained by dismantling process at the temperature of 850-1000° C. till releasing all the organic materials for purification, filtering, adsorption and absorption of liquids and gases.
